(19) United States
(12) Patent Application Publication
(10) Pub. No.: US 2004/0093188 A1
(43) Pub. Date: May 13, 2004

(54) Plant operation supporting device

(75) Inventor: Takuya Matsuno, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 10/702,431

(22) Filed: Nov. 7, 2003

(30) Foreign Application Priority Data
Nov. 12, 2002 (JP) 2002-327730

(51) Int. Cl. G06F 11/00; G06F 15/00

(52) U.S. Cl. 702/188

(57) ABSTRACT

The present invention is characterized in the following points.

In a plant operation supporting device for supporting a plant operation by transmitting and receiving data between the plant operation supporting device and a process controller, a working operation procedure described in a logic chart format can be also displayed on the screen in addition to the working operation procedure described in a flow chart format. Thus, the present invention realizes the plant operation supporting device able to flexibly cope with a steady operation, the monitoring work of a process abnormality, a device breakdown, etc.

### BACKGROUND OF THE INVENTION

1. Field of the Invention

The present invention relates to a plant operation supporting device for supporting an operation requiring a skilled operation and improving operation efficiency in alarm generation, the transition notification of a process, etc. More particularly, the present invention relates to a plant operation supporting device in which an improvement for widening application to the steady operation of a plant is made.

2. Description of the Related Art

The automatization of a manual operation mainly performed by an operator and represented by start-up, shutdown, a load change and a grade change is advanced to reduce operation cost in the plant operation.

For example, in a distributed controller, it is necessary for the operator to manually perform the operations of registration and setting in various places in the alarm generation of a device, the transition notification of a process, etc. However, the manual operation greatly depends on the skill of a skilled operator, and irregularities are caused in operation quality. Therefore, an operation automatization package able to execute the operating procedure of the skilled operator in a systemized personal computer is provided as support software for improving operation efficiency.

A non-patent literature 1 introduces the summary of a product of a supporting package “Exapilot” (registered trademark) for improving the operation efficiency as a solution base software product able to standardize and automatize an operation area mainly performed by the operator at a high operating level with operating know-how of the skilled operator.

A non-patent literature 2 introduces the summary of a product of “Exaopc” (registered trademark) which is an OPC interface package (OPC server) as an interface server product for transmitting the data of a process controller to the above supporting package “Exapilot” (registered trademark) for improving the operation efficiency.

A non-patent literature 3 introduces a product relating to a supporting package “Exapilot Lite” (Exapilot is a registered trademark) for improving the operation efficiency and characterized in that the operating procedure described in a flow chart format is performed as a semi-automation sequence.

FIG. 1 shows a procedure constructional example of the sequence described in the flow chart format in the above non-patent literature 3. Reference alphabet A designates a main procedure describing the entire sequence. Reference alphabet B designates a sub procedure 1 describing the contents of a process 1 within each process. Reference alphabet C designates a sub procedure 1-1 describing the contents of the sub procedure 1-1 within the sub procedure 1.

FIG. 2 is a functional block diagram of the distributed controller having the conventional plant operation supporting device. An upper human interface station (hereinafter called HIS) and a field control station (hereinafter called FCS) dispersively arranged in the plant are connected to a control bus 1.

FCS3 takes charge of the control of plural field devices 5 through an I/O bus 4, and transmits process data (including event information such as an alarm, etc.) 6 obtained in a control result to HIS2 by communication, and the HIS2 operationally monitors the process data.

Reference numeral 7 designates an interface server connected to the control bus 1, and the interface server 7 has a function for providing the process data 6 from the FCS3 to the side of an upper user (hereinafter called a client) utilizing the process data. This function is the same as the function of the OPC interface package “Exaopc” (registered trademark) introduced in the non-patent literature 2.

In the interface server 7, reference numeral 71 designates a real time database. The real time database 71 holds the process data 6 received through the control bus 1 from the FCS3 in real time for a predetermined period, and supplies calculated and processed information to personal computers 9 and 10 on the client side through a communication environment such as a general purpose network 8, etc. in accordance with necessity. Reference numeral 9 designates a plant operation supporting personal computer. Reference numeral 10 designates an information managing personal computer for providing strategy information.

In the interface server 7, reference numeral 72 designates a historical database. The historical database 72 periodically takes-in information from the real time database 71, and processes this information to trend information of a long period and similarly supplies the processed information to the information managing personal computer 10 through the communication environment such as the general purpose network 8, etc.

In the plant operation supporting personal computer 9, reference numeral 91 designates a procedure constructing means having a builder function. As explained in FIG. 3, a processing unit displayed by a part with respect to an executed procedure is described in a sequence coupled in a flow chart format on the working screen of the procedure constructing means 91.

Reference numeral 92 designates a display means. The display means 92 displays the working screen of the procedure constructing means 91 and an operation screen displayed in executing the constructed sequence. Reference numeral 93 designates an executing means. The executing means 93 executes the sequence confirmed by an operator on the operation screen.

Reference numeral 94 shows an example of the operation screen using a multi-window function. Reference numerals 94a, 94b, 94c and 94d respectively designate an entire display window of the sequence, a detailed sequence display window of a process (a temperature raising process in this example) being progressed at present, a sequence termination confirming dialog, and a message window relating to the sequence progress.

Control data 11 from the executing means 93 are notified to the interface server 7 through the general purpose network 8 and are further notified to the FCS3 through the control bus 1 so that predetermined sequence control is executed.

[Non-Patent Literature 1]

Yokogawa Electric homepage/product introduction/solution-based software/plant operation efficiency improvement supporting package Exapilot

Product Summary:

URL http://www.yokogawa.co.jp/EXASOFT/14 Exapilot/exapilot_{—}01.htm

[Non-Patent Literature 2]

Yokogawa Electric homepage/product introduction/solution-based software/OPC interface package Exaopc

Product Summary:

URL http://www.yokogawa.co.jp/EXASOFT/11 Exaopc/exaopc_{—}01.htm [Non-Patent Literature 3]

Yokogawa Technical Report Vol. 45 No. 1 (2001) 59/62

“Operation Efficiency Improvement Supporting Package “Exapilot Lite””

The control using the description of the flow chart format in the prior art is characterized in that the executing order of a process is taken only once in accordance with the wiring order of described parts. A non-steady operation and an abnormality coping operation are mainly used in the application object of a processing operation in which the process is executed in time series in accordance with the wiring order.

Therefore, no state of a high degree process can be detected and it is not suitable for the steady operation (steady monitoring operation) in which the operating situation is monitored by repeatedly executing the same processing.

Further, in the processing described in the conventional flow chart format, there is a case in which a process is temporarily stopped and the processing is interrupted in the confirming operation of a message and at an error generating time. The intermediate interruption of the processing was one of causes unsuitable for the steady operation.

### SUMMARY OF THE INVENTION

An object of the present invention is to provide a plant operation supporting device able to softly cope with the steady operation and the monitoring work of a process abnormality, a device breakdown, etc. by enabling the description of a logic chart format in addition to the description of the flow chart format.

### BRIEF DESCRIPTION OF THE DRAWINGS

FIG. 1 shows a description example of sequence control using the flow chart format.

FIG. 2 is a functional block diagram showing an example of a distributed controller having a conventional plant operation supporting device.

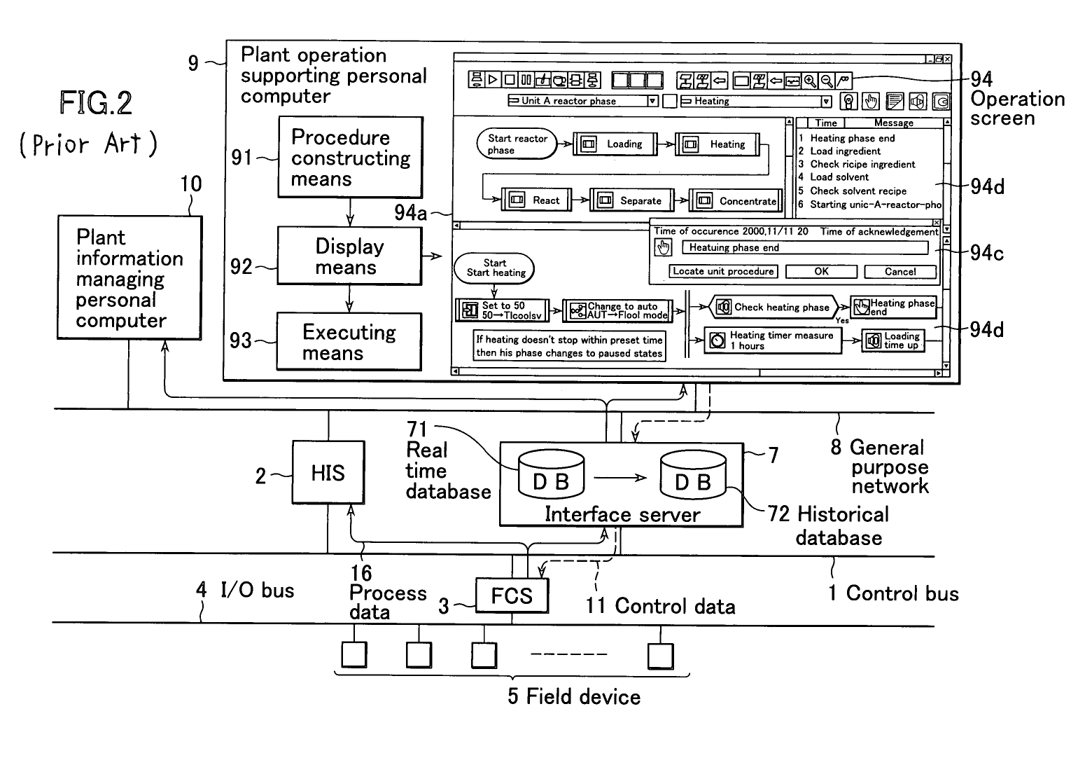

FIG. 3 is a functional block diagram showing an embodiment of a distributed controller having a plant operation supporting device applying the present invention thereto.

FIG. 4 shows a description example of logic control using the logic chart format.

### DESCRIPTION OF THE PREFERRED EMBODIMENTS

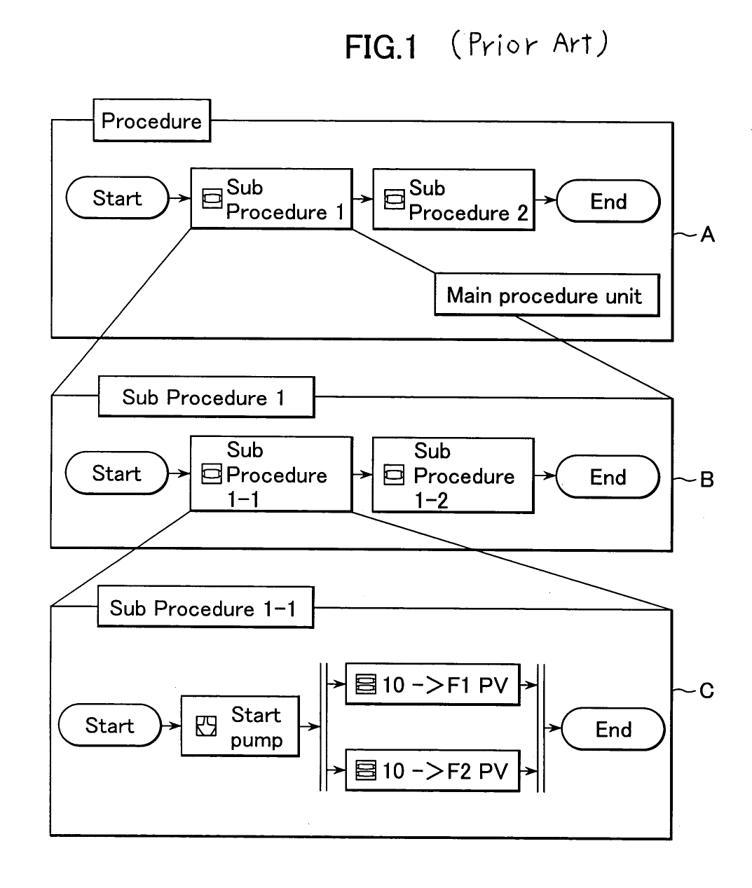

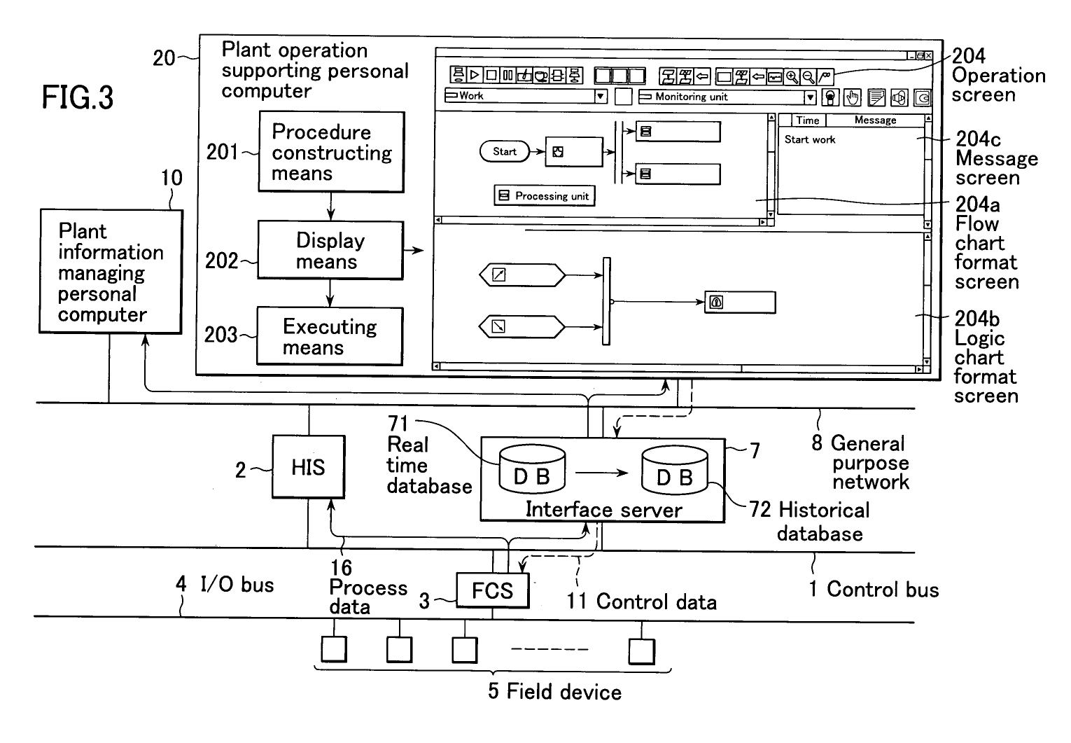

The embodiment modes of the present invention will next be explained by using the drawings. FIG. 3 is a functional block diagram showing one example of a plant operation supporting device applying the present invention thereto. The same elements as those explained in the conventional device of FIG. 1 are designated by the same reference numerals, and their explanations are omitted.

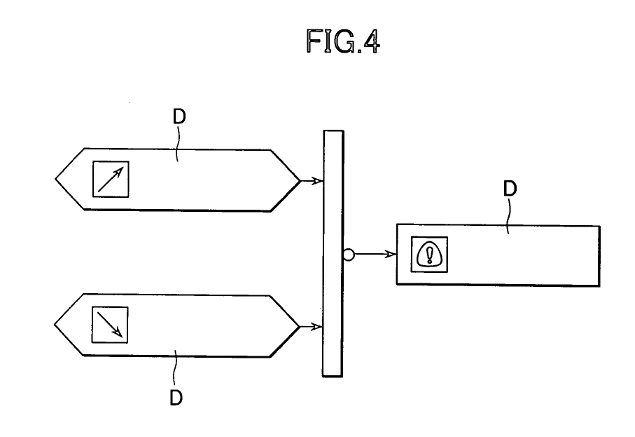

FIG. 4 shows a description example using the logic chart format introduced in the present invention and expresses a logical sum. Namely, when an event D or an event E is generated, processing F is executed. It is not time series processing as in the flow chart format, but is processing repeatedly executed at any time when a condition is formed.

The characteristic portions of the present invention will be explained by FIG. 3. Reference numeral 20 designates a plant operation supporting personal computer connected to a general purpose network. Reference numeral 201 designates a procedure constructing means having a builder function. The procedure constructing means 201 describes an executed procedure in the sequence of the flow chart format explained in FIG. 3 or the logic processing of the logic chart format explained in FIG. 4 in a processing unit displayed by a part on the working screen.

Reference numeral 202 designates a display means. The display means 202 displays the working screen of the procedure constructing means 201 and the operation screen displayed in executing the constructed sequence. Reference numeral 203 designates an executing means. The executing means 203 executes the sequence or the logic processing confirmed by an operator on the operation screen.

Reference numeral 204 shows an example of the operation screen using a multi-window function. Reference numeral 204a designates an entire display window of the sequence using the flow chart format. Reference numeral 204b designates a logic processing display window using the logic chart format. Reference numeral 204c designates a message window relating to the sequence progress or the logic processing.

Thus, in accordance with the present invention, two describing areas exist on the working screen displayed at the procedure constructing time and the operation screen displayed at the operating time. In each of the describing areas, it is possible to describe or display the flow chart format/the logic chart format. One or both of these areas can be simultaneously displayed in accordance with necessity.

In the control of the logic chart format description introduced in the present invention, all parts are operated within one period of the executing period of the control and no processing is intermediately interrupted. Namely, the repeating operation is performed every assigned executing period in accordance with a described wiring order.

In the method for describing and displaying the logic chart format, no feeling of physical disorder is caused in operability such as a definition procedure, etc. if only a change in the color of a processing result (status) and erasion of the shadow of the part are performed in e.g., the change in part so as to distinguish the display of the part of the logic chart format from that of the conventional flow chart format but so as not to cause a great difference between these formats.

In the embodiment explained above, one plant operation supporting personal computer 20 is connected to the general purpose network 8. However, it is also possible to use a construction of plural clients in which plural plant operation supporting personal computers are connected to the general purpose network 8. Further, the interface server 7 can be also constructed within HIS2 connected through the control bus 1 of the distributed process controller.

As can be seen from the above explanation, in accordance with the present invention, the logic chart format can be described for the purpose of the steady monitoring operation. Further, the application range as a plant operation efficiency improvement supporting package can be widened since the definition can be performed by the same working operation and the same sense as the conventional flow chart format.

Since the flow chart format and the logic chart format can be combined and described, it is possible to flexibly cope with the working operation required by a user without being conscious of the non-steady operation/the steady operation.

What is claimed is:

1. A plant operation supporting device having a personal computer and supporting a plant operation by transmitting and receiving data between the plant operation supporting device and a process controller through a communication bus;
said personal computer comprising:
display means for displaying a working operation procedure described in a logic chart format on the screen; and;
executing means for executing the support of the plant operation in accordance with the working operation procedure of the logic chart format displayed on the screen.

2. The plant operation supporting device according to claim 1, wherein said display means displays the screen described in one or both of the logic chart format and a flow chart format; and
said executing means executes the support of the plant operation in accordance with the working operation procedure of one or both of the logic chart format and the flow chart format displayed on the screen.

3. The plant operation supporting device according to claim 1 or 2, wherein said personal computer transmits and receives process data between the personal computer and said process controller through an interface server.

4. The plant operation supporting device according to any one of claims 1 to 3, wherein said personal computer is connected to said interface server through a general purpose network.

5. The plant operation supporting device according to any one of claims 1 to 4, wherein said plural personal computers are connected to said general purpose network.

6. The plant operation supporting device according to any one of claims 1 to 5, wherein said interface server transmits and receives said process data between the interface server and a field control station connected through the control bus of a distributed process controller.

7. The plant operation supporting device according to claim 6, wherein said interface server is constructed within a human interface station connected through the control bus of said distributed process controller.
